(19) United States
(12) Patent Application Publication
(10) Pub. No.: US 2005/0062238 A1
(43) Pub. Date: Mar. 24, 2005

(54) Point of care station

(76) Inventors: Laird Broadfield, San Diego, CA (US); Steve Thomas, Rancho Santa Fe, CA (US); Rob Sobie, San Diego, CA (US); Graham Ross, Poway, CA (US); Chris Buckley, San Diego, CA (US); Andrzei Skoskiewicz, Menlo Park, CA (US); Stephen Wahl, Palo Alto, CA (US); Roshi Givechi, San Francisco, CA (US); Mark Siminoff, San Jose, CA (US); Paul Frey, San Francisco, CA (US); Adrian James, Palo Alto, CA (US)

Correspondence Address: CARDINAL HEALTH, 7000 CARDINAL PLACE, LEGAL DEPARTMENT - INTELLECTUAL PROPERTY, DUBLIN, OH, 43017, US

(21) Appl. No.: 10/810,379

(22) Filed: Mar. 26, 2004

Related U.S. Application Data
(60) Provisional application No. 60/458,877, filed on Mar. 28, 2003.

(51) Int. Cl. B60R 1/00

(52) U.S. Cl. 280/1

(57) ABSTRACT

This invention is directed to a point-of-care (POC) station that comprises a mobile cabinet with securable compartments and a pylon release mechanism. The POC station also comprises an immovable pylon, an articulated arm, and a terminal having a monitor. The POC station extends the medication and supply infrastructure into the patient room.

### RELATED APPLICATIONS

This application is based on and claims priority to U.S. Provisional Patent Application Ser. No. 60/458,877, filed Mar. 28, 2003.

### I. BACKGROUND OF THE INVENTION

A. Field of Invention

This invention relates to apparatuses and methods for providing health care. More particularly, this invention is directed to apparatuses and methods for providing care to a patient through supplying medication and other items as well as education, communication and entertainment functions in the patient room.

B. Description of the Related Art

It is well known in the medical community and in particular in hospitals, to provide centrally located medication and supply dispensing stations. Such stations serve several functions including the distribution of medicines and supplies to patients. These stations work well for their intended purpose. However, there are disadvantages to such centralized stations. One disadvantage is that the nurses must walk back and forth between the station and each patient that they visit in order to retrieve and deliver needed supplies and/or medications. This can be tiresome for the nurses and has the potential to increase the time delay for a patient wanting caregiver assistance.

A problem that is well known in the medical community relates to the limited space available in patient rooms—especially near the patient's bed. As a result, there is tremendous competition for the bedside space. One company that has addressed the needs of caregivers and patients is Cardinal Health Inc. of Dublin, Ohio. It presently supplies the Pyxis line of healthcare automation products and information services. Representative products include Pyxis MedStation® automated medication management system, Pyxis Veri5™ medication verification software, Pyxis CUBIE® family of products for securing the medication both during transport from the pharmacy to a MedStation, and Pyxis SupplyRoller® mobile supply management system.

One especially innovative product is the Pyxis PatientStation® integrated point-of-care technology system. Pyxis PatientStation is a bedside information technology system that provides clinicians and patients with information and communication choices at the point of care. The system works to reduce medication errors, improve patient safety and enhance caregiver efficiency.

While it is known to provide products such as these having clinical applications or patient applications, no known product has combined both clinical (e.g., drug and supply dispensing) and patient (non-clinical) types of functionality in one device in the patient's room. In particular, it is not known prior to this invention to provide: (1) medication dispensing; (2) supplies dispensing; (3) medication administration/verification; and, (4) patient applications all in one product.

The present invention also addresses the disadvantage centrally located medication and supply stations and the problem of limited bedside space. This innovative point of care station provides medication and supply items as well as education, communication, entertainment and other functions in the patient room.

### II. SUMMARY OF THE INVENTION

The point of care station of this invention combines secure clinical application access, automated storage, dispensing, verification and administration technology for medications and supplies at the patient bedside. It improves nurse workflow and efficiency while increasing patient safety and enhancing patient satisfaction.

Medications and supplies are stored and administered at the patient bedside. These include the fastest moving medications and patient-specific medications and supplies. Administration and verification can now be accomplished in a single step. A major advantage of the point of care station of this invention is that the majority of ordered medications for the patient, including those medications ordered at scheduled times as well as those ordered if needed (PRN's), can now be stored and made readily available at the bedside. The present invention securely stores medications (within locked compartments) and, through the use of computer programs, can track a medication or supply and account for (inventory) its use. The point of care station cabinet can also be used to store patient-specific medications such as topical ointments, ophthalmic, etc. The patient-specific medications and supplies can include a set of items for a specific type of surgery or procedure that the patient has had (e.g., heart surgery, knee replacement, child birth, etc.). Theoretically, even controlled substances could be contained within the cabinet, but the facility may not desire to expand the number of locations where these mediations are stored for safety purposes.

The point of care station is designed with an open architecture and supports both clinical and patient applications on a common platform at the bedside. The principle user of the cabinet of the point of care station is the caregiver. Patients may also use the compartments in the cabinet of the station (to store personal items) and they will certainly use the top of the cabinet as a working or storage surface. Restocking staff will also interact with the station as they refill the cabinet with replacement medications and supplies.

The station cabinet may be restocked in the patient's room or outside of the patient's room, in the facility hall for example. If restocking is in-room, the station would only be moved from its bedside location during cleaning procedures both during and between patient stays, and when caregivers needed additional space, such as in an emergency. According to one aspect of this invention, a point of care station includes a cabinet, a pylon assembly and docking means for use in docking the cabinet to the pylon assembly and also for use in undocking the cabinet from the pylon assembly. Docking does not necessarily only mean actual physical contact but is intended to include a communication link such as a radio frequency or infrared connection between the cabinet and pylon or between the cabinet and terminal. The most preferred docking is actual physical locking and electrical connection between the cabinet and pylon.

According to another aspect of this invention, the cabinet has at least a first securable compartment that is adapted to hold items for use concerning a medical patient, such as medications and supplies. According to another aspect of this invention, the pylon assembly includes a processing unit (e.g., motherboard or personal computer) and the point of care station also includes a terminal with display that is operatively connected to the processing unit (e.g., hard wired or wireless).

According to still another aspect of this invention, the terminal provides access to both clinical information and non-clinical information and the point of care station includes clinical access means for use in accessing the clinical information. According to another aspect of this invention, the point of care station cabinet includes at least one securable medical compartment for use in holding medical supplies and at least one supply compartment for use in holding general supplies for use concerning the medical patient. The station may also include a securable compartment for use only by the patient. The term compartment is meant to include any one of the parts into which an enclosed space is divided. For example, this would include boxes, bins, areas with doors, shelves, drawers and the like. As used herein, the word drawer can mean any of these types of compartments. The most preferred compartment is a drawer.

According to another aspect of this invention, access to the point of care station is controlled using at least one of the following: a password, a magnetic card reader, biometric reader, proximity reader, a radio frequency identification reader, bar code reader, and a touchscreen monitor. Magnetic card readers, radio frequency identification readers, proximity readers and bar code readers are mature technologies and are well understood by those skilled in the art of machine communication. A biometric reader includes fingerprint scanners and retina scanners. A representative biometric reader is the Pyxis BioID™ biometric positive identification security system. This device enhances system security by physically verifying a user's identity with a fingerprint scan. A user would enter their login ID into the system and place their finger on the Pyxis BioID fingerprint scanner to gain access to the inventive station.

Representative of a terminal is a commercially available product called Pyxis PatientStation integrated point of care technology system. The PatientStation machine is an information, communication and entertainment device for patients and caregivers (e.g., clinical data and information).

According to another embodiment of this invention, the cabinet is mechanically and electronically docked to the station pylon assembly, which is in turn permanently fixed to a room surface, such as the floor, wall or ceiling. In this embodiment, the pylon assembly physically holds (docks) the station firmly in position. The cabinet is released (undocked) from the pylon via a mechanical foot pedal mounted on the base of the cabinet. In another embodiment, there is docking without physical contact such as infrared or radio frequency communications and energy transmissions. As used herein, pylon assembly means any structure or mechanism that acts as an anchoring device.

One advantage of this invention is that placing the final distribution point within the patient room is more convenient for the nursing staff. Another advantage of this invention is that it improves patient care by streamlining the final stage of medication distribution.

Still another embodiment of this invention provides the ability to use detailed patient profile information software to verify the “five rights” of medication management: correct or right patient, right drug, right dose, right time, and right route. A representative commercially available product for such an embodiment is the Pyxis Veri5 medication verification software application. Using this application and bar code reader, the nurse scans their badge, the patient's wristband and the medication. If an error is identified, a warning is sounded.

Thus, there is disclosed a point of care station comprising: a cabinet having at least a first securable compartment that is adapted to hold items; a pylon assembly; and, docking means for use in docking the cabinet to the pylon assembly and also for use in undocking the cabinet from the pylon assembly. Additionally, the point of care station should include a processing unit and a terminal that are operatively connected together (e.g., hard wired or wireless). The terminal can contain display means and input means and will also provide means to access clinical and non-clinical information. The terminal, through preferably a touchscreen monitor, will be able to record/report the status of each securable compartment. The display (monitor) will supply non-clinical information to the patient such as videos, television and the like. On the other hand, the monitor will display to the clinician medical records, test results, imaging data. Physician orders and the like. Preferably, the pylon assembly is fixed to an immovable surface and preferably has an articulated arm attached to it, which supports the terminal. Activation of the system can be accomplished through the use of a magnetic card, biometric reader-sensor, radio frequency identification systems, proximity readers, bar code readers and simple entry of a password on the touchscreen.

Preferably, the cabinet is on wheels so that upon undocking from the pylon assembly the cabinet could be easily moved during an emergency or to a replenishment station. In addition, it is preferred that the cabinet have at least one drawer wherein only the patient may have access to it. In similar fashion, there would be drawers or compartments to which the patient would not have access.

The present invention is also directed to a method of managing medical items comprising the steps of:
(1) providing a point of care station comprising:
   a. a cabinet having at least a first securable compartment;
   b. a pylon assembly comprising a processing unit;
   c. said cabinet and said pylon assembly being docked; and
   d. a terminal;
(2) providing a first security information to unlock said first compartment;
(3) opening said first compartment; and
(4) adding items into said first compartment.

The method used can also include the step of providing first security information to said terminal to unlock the first compartment and then opening said first compartment and removing one or more items therefrom. The method of the present invention also includes a step of closing and locking the first compartment.

The present invention is also directed to the method of accessing information comprising the steps of:
(1) providing a patient care station comprising:
   a. a cabinet having at least a first electronically securable compartment;
   b. a pylon assembly comprising a processing unit;
   c. a terminal; said station being proximate to the patient's bedside;
(2) providing first security information to said terminal; and
(3) accessing clinical information.

Another advantage is that the point of care station may be integrated into a larger system for controlling supplies and medicines. Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings, which form a part hereof and wherein:

FIG. 1 is a perspective view of the point of care station according to this invention.

FIG. 2 is a perspective front view of the pylon assembly.

FIG. 3 is a perspective view of a terminal used with the point of care station.

FIG. 4 is a perspective view of the articulated arm and terminal of the invention.

FIG. 5 is a partial view of the terminal of the invention.

FIG. 6 is a perspective view of the point of care station with drawers extended.

FIG. 7 is another perspective view of the point of care station with drawers extended.

FIG. 8 is a lower perspective view of the cabinet showing illumination lights on the cabinet handle.

FIG. 9 is a perspective view showing the cabinet drawer rail.

FIG. 10 is a perspective view of the lower portion of the cabinet showing the foot pedal for releasing the cabinet from the pylon.

FIG. 11 is a perspective view of the lower portion of the cabinet shown partially disassembled with the foot pedal assembly revealed.

FIG. 12 is a perspective side view similar to FIG. 11 but showing the foot pedal assembly from another angle.

FIG. 13 is a top perspective view of the back of the cabinet.

FIG. 14 is a lower another top perspective view of the back of the cabinet showing the release mechanism and the power/communication contacts.

FIG. 15 is a close-up view of the portion of the pylon assembly including portions of the latch mechanism and the power/communication contacts that connect with the corresponding items shown in FIG. 16 of the cabinet.

FIG. 16 is a close-up view of the bottom portion of the POC station including portions of the latch mechanism and the power/communication contacts that connect with the corresponding items shown in FIG. 15.

FIG. 17 is top view of a channel rack assembly used to build a cabinet.

FIG. 18 is an external perspective view of a cabinet during assembly showing a channel rack assembly attached to a header weldment.

FIG. 19 is an internal perspective view of a cabinet during assembly showing a pair of channel rack assemblies to a base weldment.

FIG. 20 is a perspective view of a cabinet during assembly showing swing assembly brackets attached to the base weldment.

FIG. 21 is a perspective view of an alternative embodiment of the invention.

FIG. 22 is a global view of a hardware configuration installation.

### IV. DESCRIPTION OF THE PREFERRED EMBODIMENT

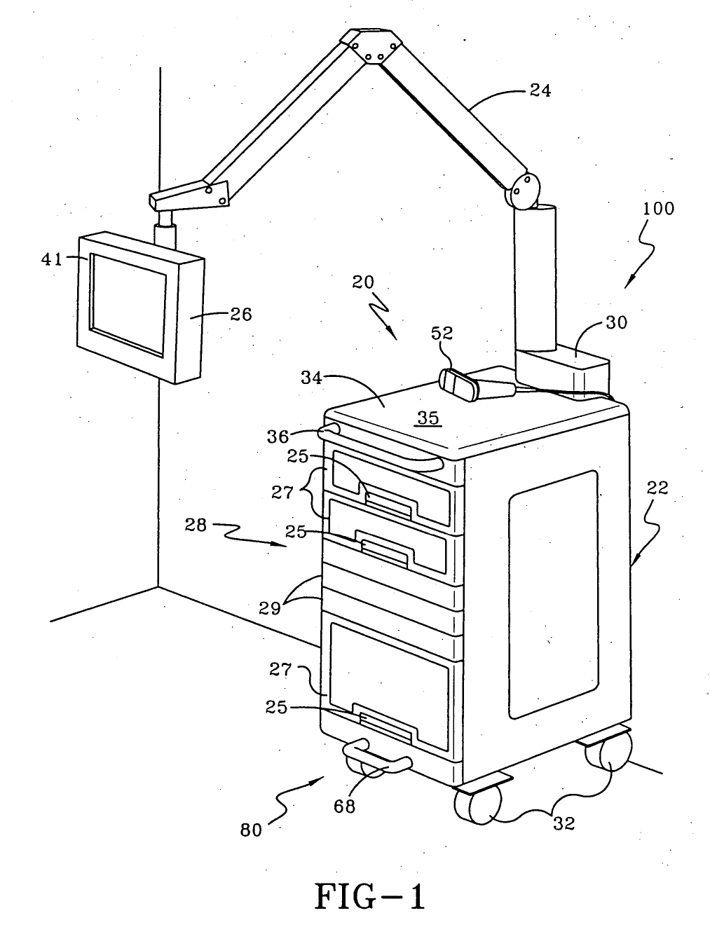

Referring now to the drawings wherein the figures are for purposes of illustrating a preferred embodiment of the invention only and not for purposes of limiting the same. FIG. 1 shows a point of care (POC) station 20 according to this invention. The POC station 20 includes a cabinet 22, a pylon assembly 30 and docking means 100 for use in docking the cabinet 22 to the pylon assembly 30 and also for use in undocking the cabinet 22 from the pylon assembly 30. As shown, the cabinet 22 includes a plurality of modular storage compartments, here shown as drawers 28. The number and type of drawers 28 used can be custom configured within the cabinet 22 to match the medication and supply needs of the facility. Preferably, there are at least two types of drawers 28, supply drawers 27 for use in holding general supplies and medical drawers 29 for use in holding medical supplies, such as medicine. Any of the drawers 28, but especially the medical drawers 29, are securable. The drawers 28 that are secured are electronically controlled. In one embodiment, the medical drawers 29 are securable and electronically controlled and the supply drawers 27 are manually controlled. By manually controlled it is meant that a person, generally the patient, can open and close a supply drawer 27 with little or no preliminary requirements such as providing a password or code. At least two embodiments are envisioned. In one embodiment, the user can open and close the supply drawer 27 by hand with no impediments—similar to conventional storage drawers. In another embodiment, the supply drawers 27 are accessible through a first securing means and the medical drawers 29 are accessible through a second securing means. Preferably, the first and second securing means are distinct because the first securing means is intended to allow access to the patient but no one else, while the second securing means is intended to allow access to the appropriate caregiver(s) but no one else. Thus, even the patient cannot gain access through the second securing means.

In another embodiment, different caregivers will have access to different mixtures of medications and supplies, so they may have different levels of security access. Also, restock technicians may have different levels of security access. The securing of the drawers 28 will be discussed further below.

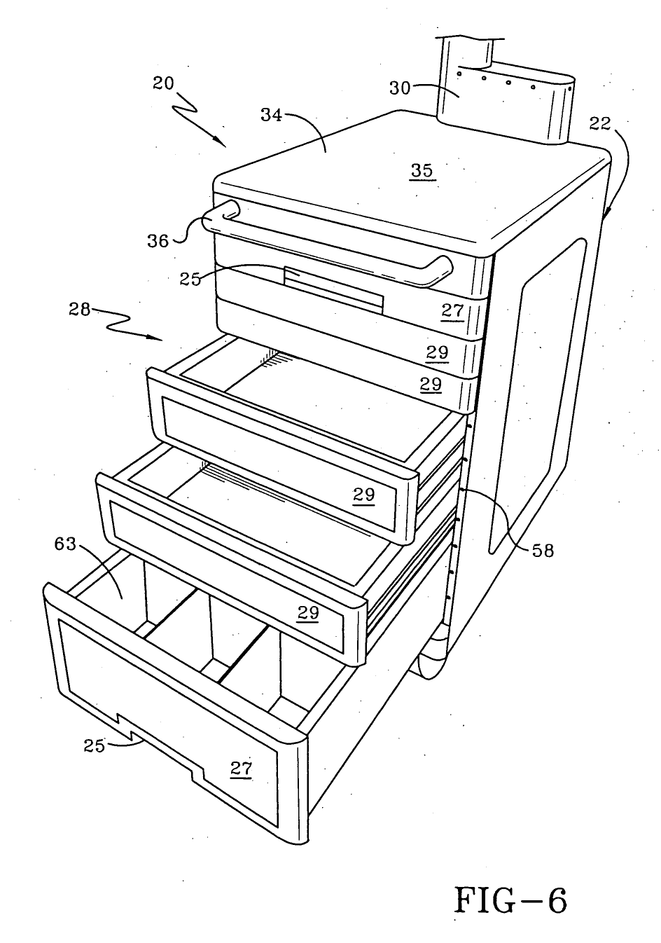

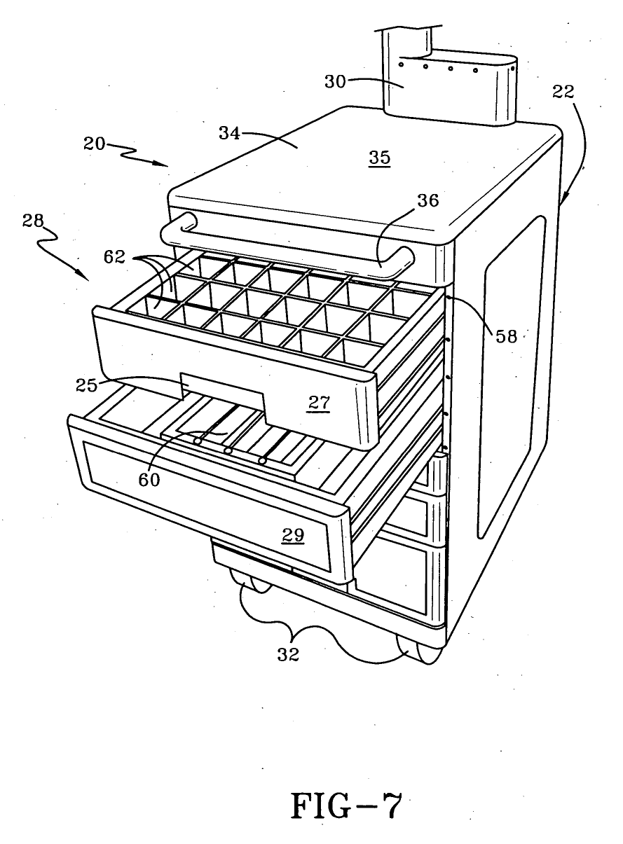

With reference now to FIGS. 1 and 6-7, a typical configuration of drawers 28 will, in one embodiment, be similar to that found in the presently commercially available product known as a MedStation automated medication management system from Cardinal Health, Inc., Dublin, Ohio. A MedStation system can be configured with different kinds of drawers 28 that include drawers with CUBIE receptacles, matrix drawers of different heights, and MiniDrawers™.

CUBIE, Matrix and Double Deep Matrix are terms understood by those skilled in the art. CUBIE receptacles 60, drawers 28 and related dispensing machines are fully disclosed in U.S. Pat. Nos. 6,116,461 and 6,338,007, which are incorporated herein by reference. There can also be patient specific CUBIE receptacles 60 that contain multiple medications and supplies for a single patient. Any drawers 28 may also include dividers 62 or compartments 63 as shown.

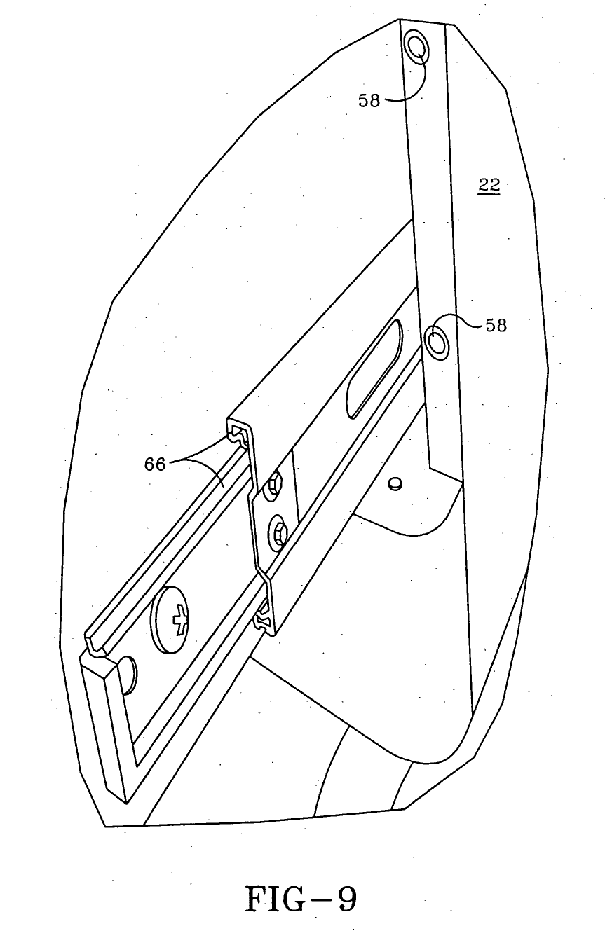

With reference now to FIGS. 1, 6-7 and 9, in a preferred embodiment, supply drawers 27 have handles 25, whereas medical drawers 29 do not. It is also preferred that the securable medical drawers 29 automatically open a relatively short distance, e.g., less than 2 inches, from the cabinet 22 when they are electronically unlocked. This may be accomplished by spring-loaded solenoids. Supply drawers 27 need to be manually opened and preferably do not automatically open when unlocked. However, it is contemplated that for some applications it may be desired to have the supply drawers 27 automatically open as well. The particular drawer 28 design can be any chosen with sound engineering judgment but preferably includes rails 66 (FIG. 9) that slidably connect the drawers 28 to the cabinet 22 in a well-known manner. Preferably, indicator means 58 are used in indicating if a drawer 28 is unlocked or if the drawer 28 contains the desired supplies. In one preferred embodiment, the indicator means 58 is an indicator light 58 mounted on a front surface of the cabinet 22, as shown, so that it can be easily observed when a drawer 28 is open. Alternatively, the indicator lights 58 could be on the drawers 28. There could also be indicator means on the display 26. The cabinet 22 may be movable. Thus, in a preferred embodiment the cabinet 22 has at least a first ground-engaging wheel 32, four shown, and at least a first handle 36 for use in transporting the cabinet 22.

As shown in FIGS. 1 and 6-7, the cabinets 22 have a top work surface 34. Research shows that any flat surface in a patient's room will likely be used to accumulate objects belonging to the patient or the health care facility. This is especially true for surfaces immediately next to the bed. If the intention is for the cabinet 22 to be removed periodically for restocking, this places a burden on caregivers to relocate miscellaneous objects that may have accumulated on its top surface 34. This problem can be solved providing the work surface 34 with a tray 35 that can be moved with respect to the cabinet 22. The caregiver can then relocate a collection of objects in one action. In one embodiment, this tray 35 can dock to or attach with a portion of the pylon assembly 30 in order to keep any objects placed on it within reach of the patient. It is likely that objects placed in this location have been put there to allow easy access from the lying position, placing this tray 35 elsewhere in the room while restocking occurs would be inconvenient.

Bar code reader 52 in FIG. 1 is shown as preferably connected to the pylon 30. In other embodiments, the bar code reader or other machine communication device (such as a symbology reader) could be placed on the arm 24, the terminal 41 or the cabinet 22. Wireless bar code readers and other devices are also contemplated herein.

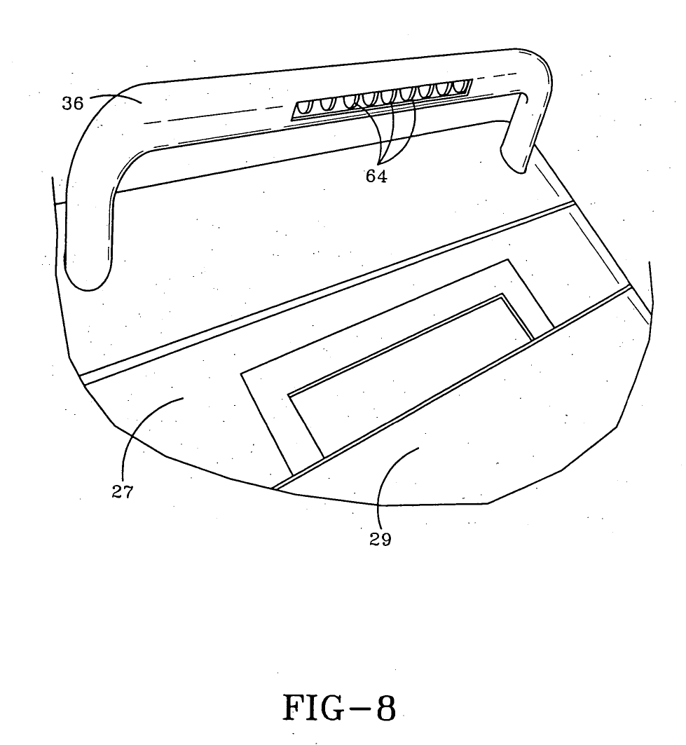

With reference now to FIGS. 1 and 8, one issue that arose during the development of this POC station 20 was the sensitivity among caregivers to disturbing a sleeping patient. Along with noise, light was an important consideration. Some caregivers choose to carry a small flashlight with them to avoid turning on the main room lights while checking on patients. Because the POC station 20, holding various medical and supply items, brings more activity into the patient room than the existing centralized system, any extra disturbance this might cause needs to be minimized. To help minimize such disturbance, in a preferred embodiment the cabinet 22 includes an illumination light(s) 64 inside the handle 36 for illuminating the drawers 28. In this way, an opened drawer's 28 contents are illuminated obliquely. This illumination light 64 may be positioned in the cabinet handle 36 as shown or attached to the underside of the handle 36. Preferably, the illumination light 64 is turned on when a drawer 28 is opened. The drawers 28 could also incorporate translucent bins and gentle illumination from below to silhouette the drawer 28 contents.

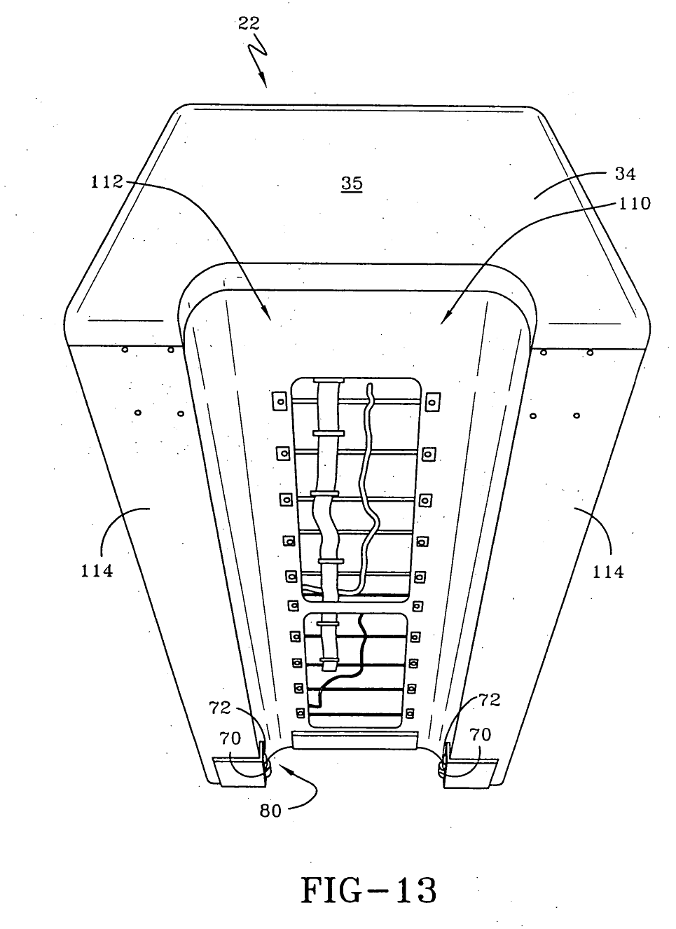

With reference now to FIGS. 1 and 13, as noted above, the drawers 28 that are secured are preferably electronically controlled. Thus, it is preferred that the cabinet 22 be equipped with a manual release mechanism 110 for use in unlocking the drawers 28 in case there is loss of power to the system, and/or some electrical computer malfunction prevents normal access to the drawers 28. Access means 112 is provided so that the manual release mechanism 110 can be accessed. In a preferred embodiment, at least one of the cabinet back panels 114 provides the required access means 112. The caregiver uses a key to open the panels. This gives the caregiver access to each drawer's 28 manual release mechanism 110. Individual CUBIE receptacles 60 are opened with a sharp instrument such as a screwdriver. This action destroys the CUBIE 60 lid yet allows access to the medications in the event of power failure.

Following is a brief discussion of typical specific features and options for a cabinet 22 according to this invention. It should be noted, however, that these are just examples and numerous modifications can be made and still fall under the invention as herein described and claimed.

The weight of a typical device would be about 175-225 pounds when fully loaded, and about 150 pounds when empty. Ground clearance should be at least about 5 inches to allow IV stand legs to pass underneath the cabinet. The wheels 32 should be 4 castors, with 2 fixed, and 2 pivoting (on handle end). The cabinet shell comprises the top plate 35 and may be made of corian, the 2 sides, bottom plate, and rear center can be fixed sheet metal, and the 2 rear side panels may be removable sheet metal.

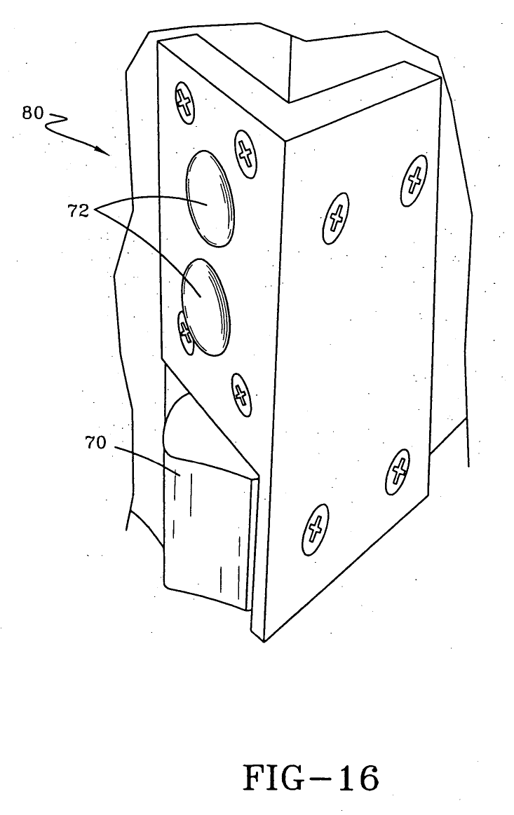

With reference now to FIGS. 1-2 and 15-16, because the cabinet 22 can be physically undocked from the pylon assembly 30 at any time, there is a risk of its unauthorized removal from the facility. Theft could possibly be deterred by installing, in addition to proper signage, a security system of some type. One type of security system that could be used with this invention is a system tied into the conventional hospital security system, such as to a security guard station. In this case, when a cabinet 22 is removed from a certain predetermined hospital boundary, an alarm would be activated. Another type of security system may include a brake and/or sonic alarm mounted on the POC station 20 that detects when unauthorized removal of a cabinet 22 has occurred. An inexpensive system similar to this is installed on supermarket shopping cabinets.

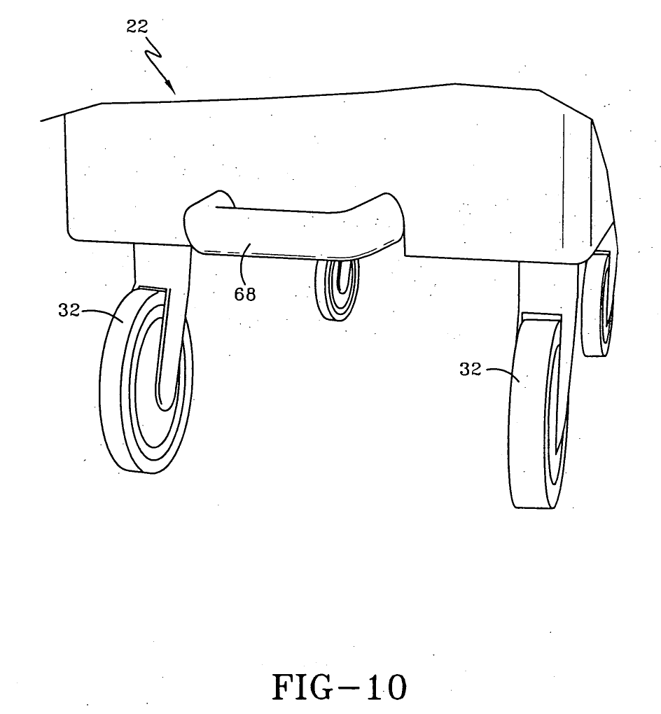

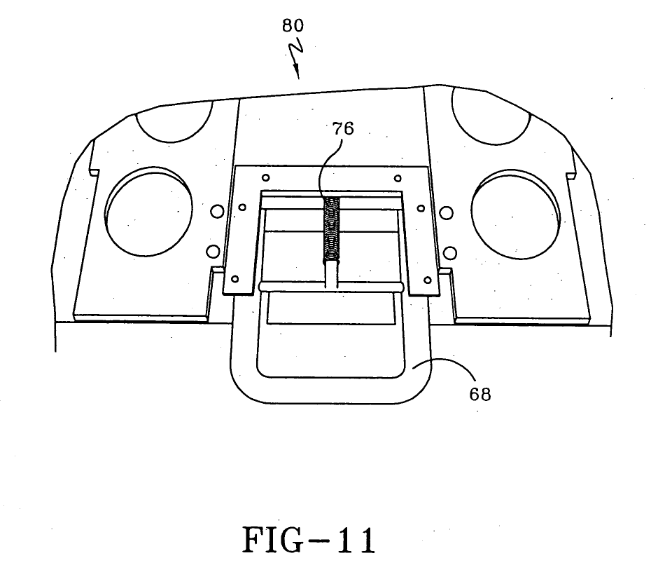

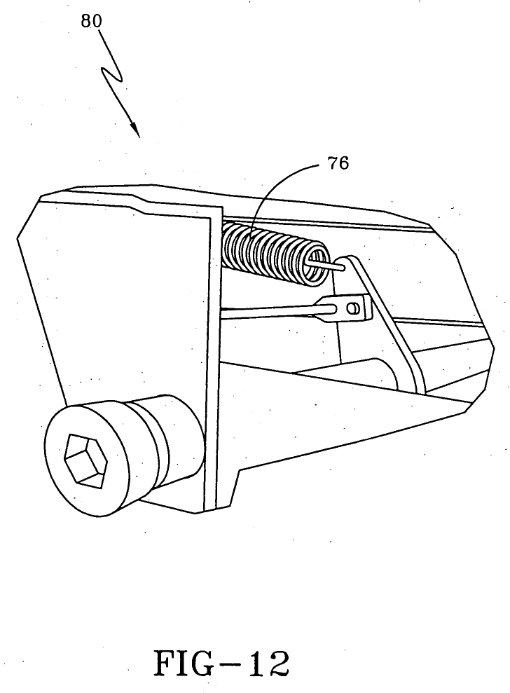

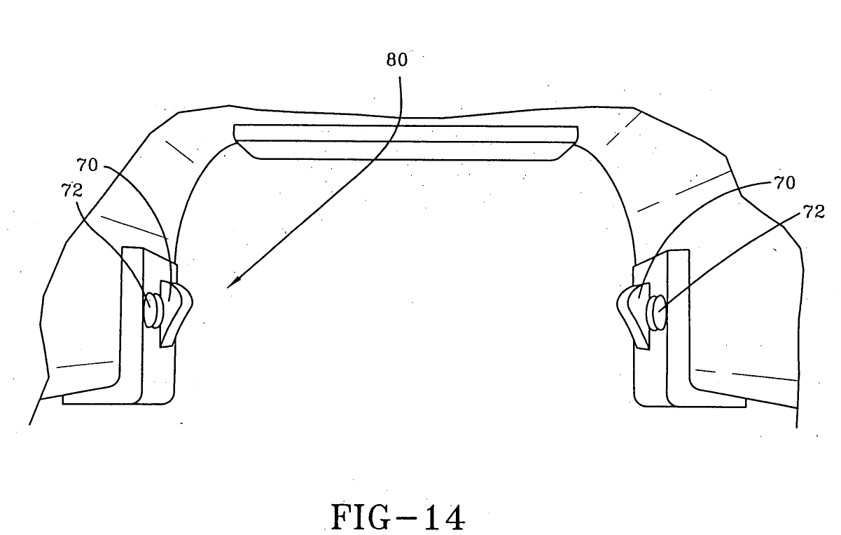

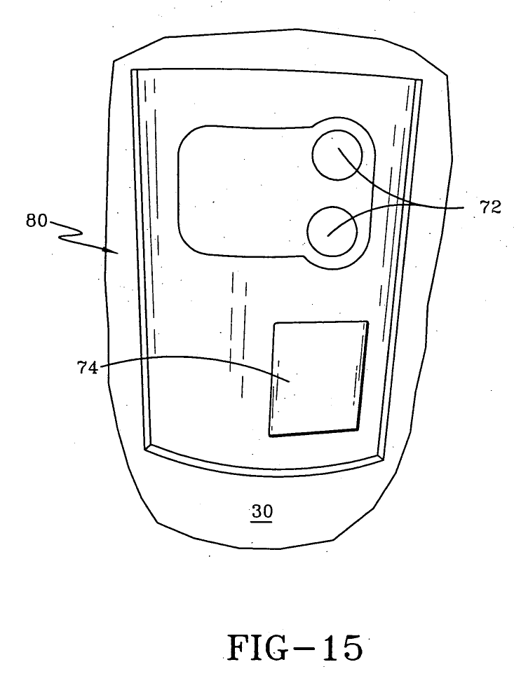

With reference now to FIGS. 1-2 and 10-16, a preferred docking means 100 includes a latch release mechanism 80 for use in physically locking the cabinet 22 into the docked position and for use in unlocking the cabinet 22 from the docked position. In a preferred embodiment, the pylon assembly 30 acts as the docking point for the cabinet 22. The cabinet 22 is released, or unlocked, by using a foot pedal 68 located at the base of the cabinet front. The latch release mechanism 80 includes the foot pedal 68 as well as a spring 76 (FIGS. 11 and 12) that biases a pair of extending members 70 outwardly from the cabinet 22. The extending members 70 are received with receiving zones 74 (FIG. 15) positioned on a surface of the pylon assembly 30. The extending members 70 are angled, as shown, so that the cabinet 22 is easily docked by pushing it firmly against the pylon assembly 30 where it locks in place as the extending members 70 are received within the receiving zones 74. To release the cabinet 22 from the pylon assembly 30, the operator simply presses the foot pedal 68 and thereby overcomes the biasing force of the spring 76. The cabinet 22 is then free to be moved as necessary. A separation means may be provided for separating the cabinet 22 from the pylon assembly 30 when the cabinet 22 is released from the docked position. In one embodiment, the separation means uses an internal spring (not shown) to provide the necessary force to disengage and push the cabinet 22 away from the pylon assembly 30. In another embodiment, a number of push pins (not shown) can be used to push the cabinet 22 away from the pylon assembly 30.

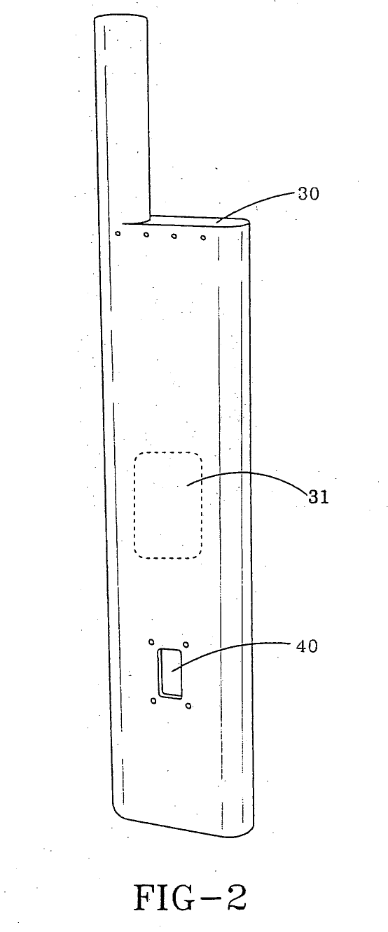

With reference now to FIGS. 2 and 13-16, preferably inside the pylon assembly 30 is a networked processing unit, e.g., mother board or computer 31, which drives the POC station 20 software. Thus, the pylon assembly 30 provides power and a communication link 72 to the cabinet 22 when the cabinet 22 is docked to the pylon assembly 30. This link may be physically made using at least one, preferably four, power/communication contacts 72. As shown, these contacts 72 may be provided on both the cabinet 22 and the pylon assembly 30 and create the proper electrical and communications connection between the cabinet 22 and the pylon assembly 30 when they are docked and the contacts 72 are in physical contact. Preferably, these contacts 72 are positioned near the extending member 70 and the receiving zone 74 connection to maximize connection between the contacts 72. The contacts 72 supply power and data to the cabinet 22. The contacts 72 can have separate contacts for power and for communications. In an alternate embodiment, shown in FIG. 2, a power/communication connector 40 may be positioned in the middle of the pylon assembly 30 as shown. In either case, the pylon assembly 30 is preferably fixed to a room surface, such as the floor, wall or ceiling. In an alternative embodiment, connections between components of the POC station 20 may use conventional wireless technology.

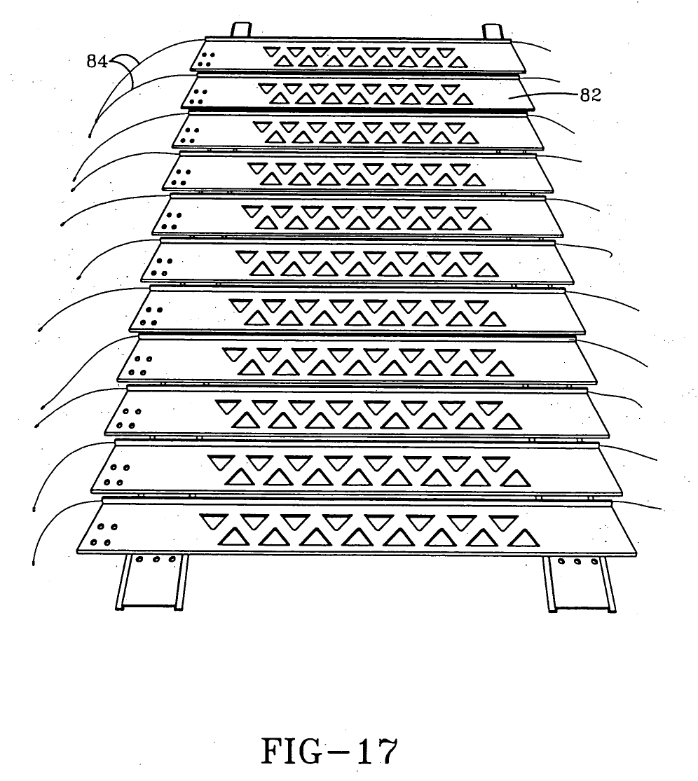

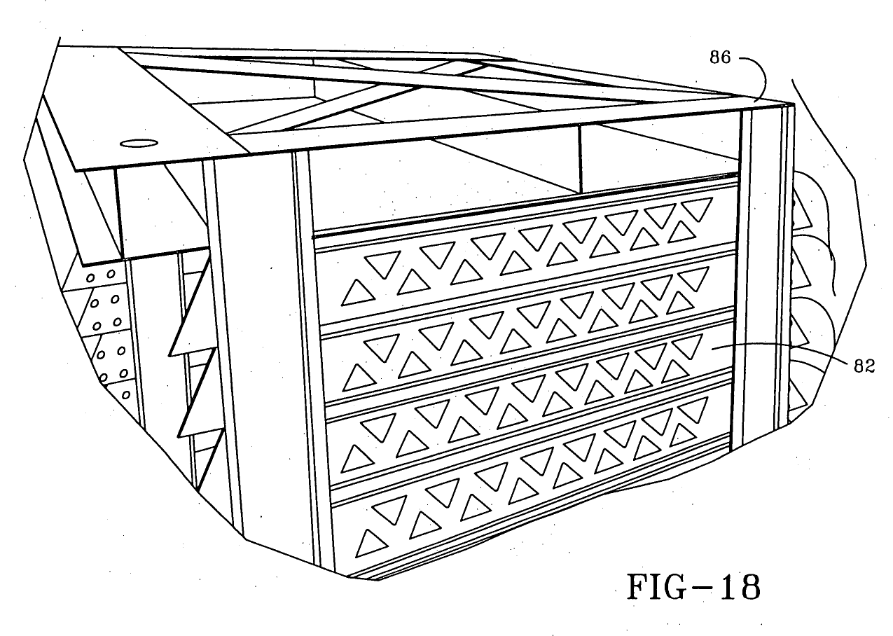

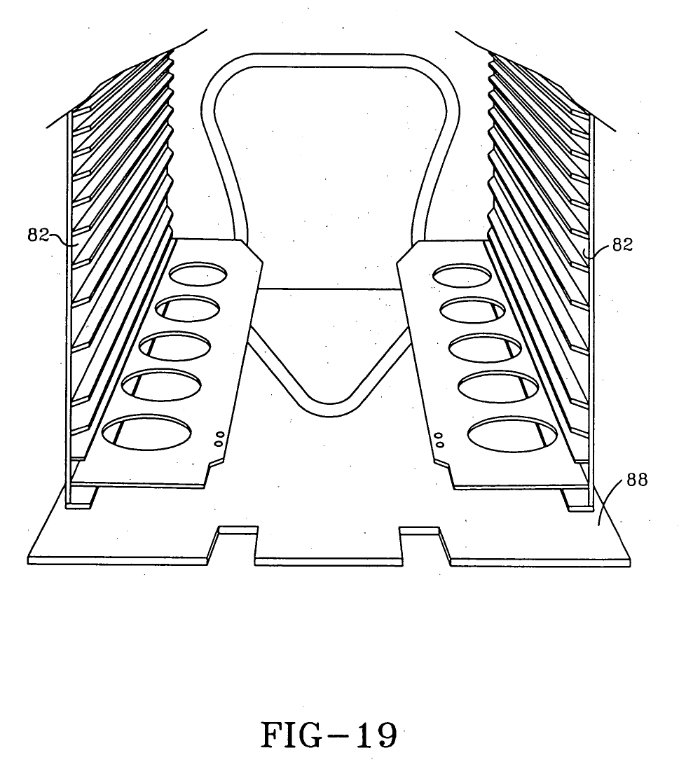

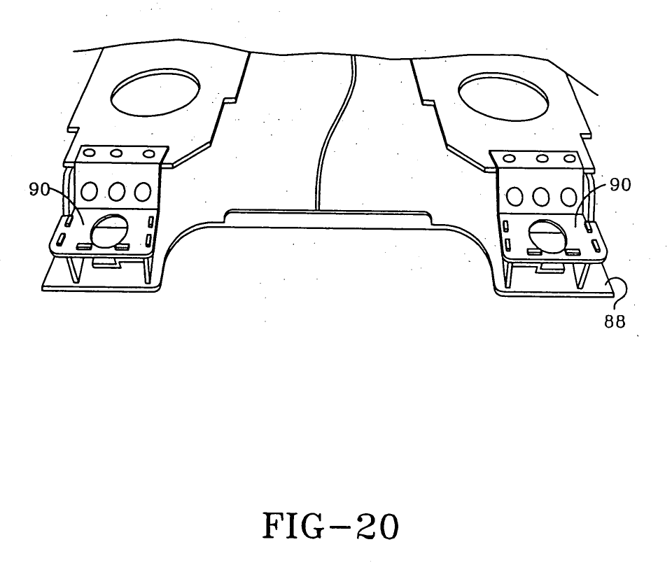

With reference now to FIGS. 1, 13 and 17-20, the basic construction techniques for the cabinet 22 can be any known that utilizes sound engineering judgment and thus will not be described in great detail. Nonetheless, some portions of the preferred construction will now be reviewed. FIG. 17 shows a channel rack assembly 82 used to form the sides of the cabinet 22. Drawer LED cables 84 are used to electronically detect drawer conditions as discussed above. FIG. 18 shows how the channel rack assembly 82 is connected to a header weldment 86 in the formation of a cabinet 22. FIG. 19 shows a back view of the partially assembled cabinet 22 and more particularly shows a pair of channel rack assemblies 82 connected to a base weldment 88. FIG. 20 shows a pair of swing assembly brackets 90 attached to the base weldment 88. The swing assembly brackets 90 are used to support the previously described extending members 70.

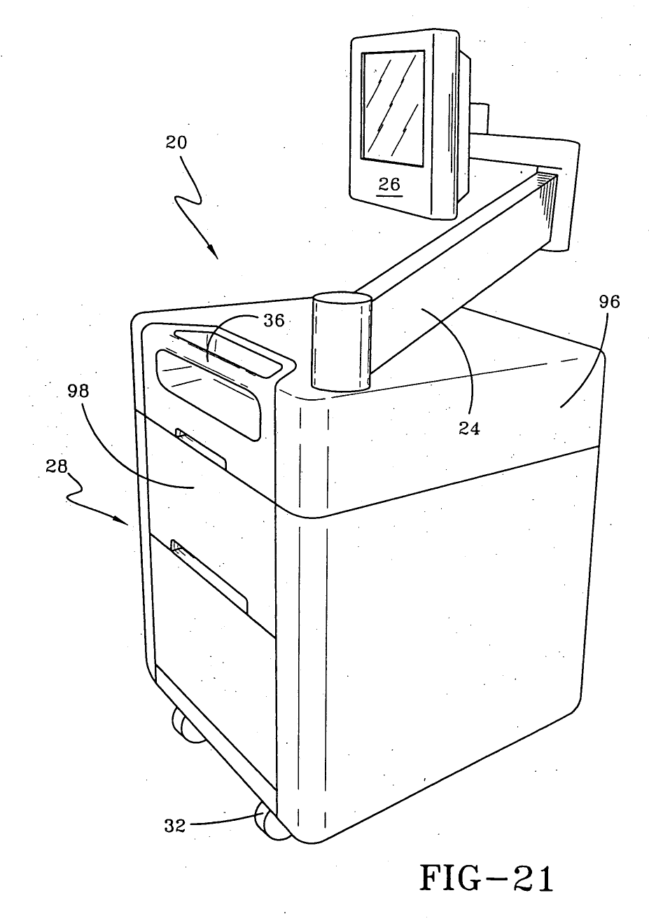

With reference now to FIG. 21, a cabinet 22 having an alternative design will be described. The basic construction is the same as described above. However, in this embodiment, the cabinet 22 has an outer shell 96 that remains stationary and, where applicable, acts as the pylon assembly 30. A wheeled cart 98, containing the drawers 28, is selectively received within the outer shell 96. With this design, the cart 98 can be detached from the shell 96 and taken out of the patient room, for example, to restock the drawers 28. The cart 98 can then be re-attached to the shell 96 as desired.

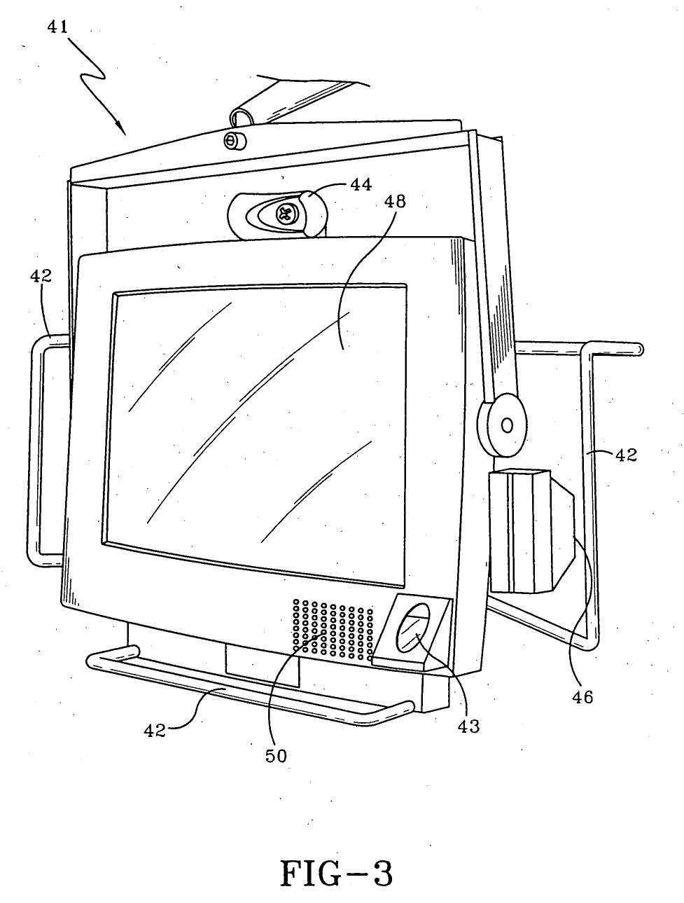

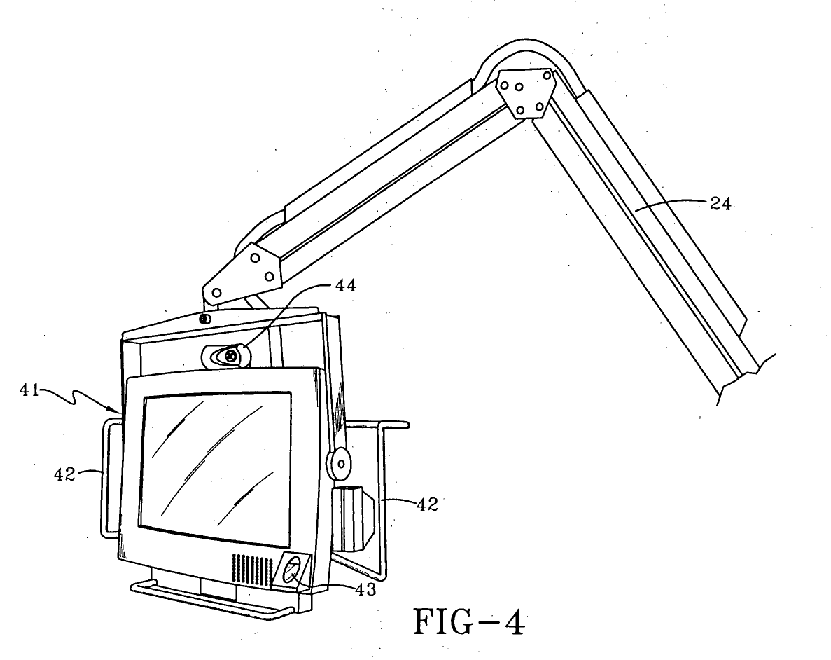

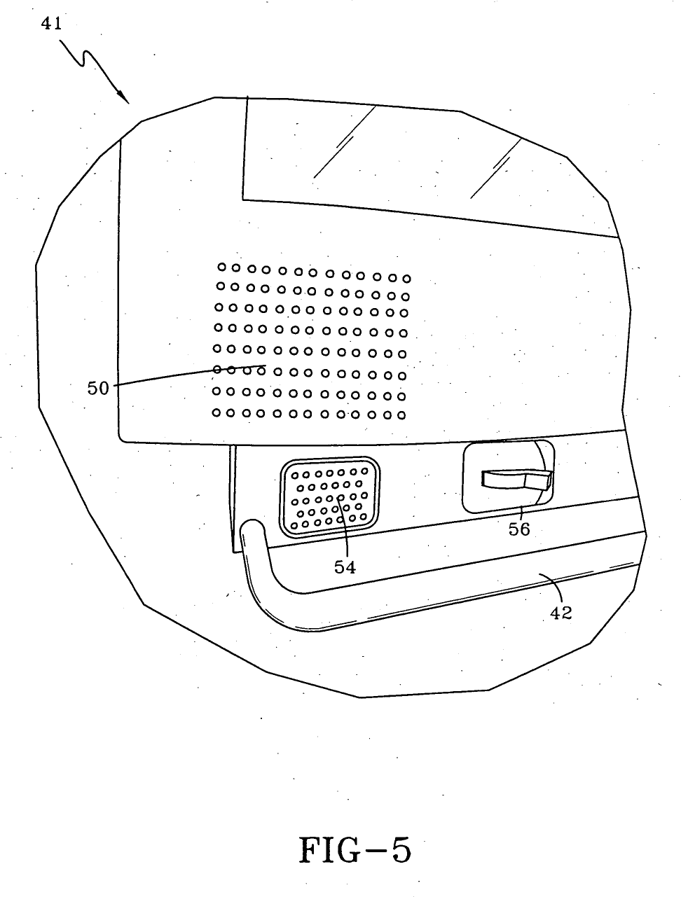

With reference now to FIGS. 1 and 3-5, in a preferred embodiment, the POC station 20 also includes a terminal 41 that is operatively connected to a processing unit 31 preferably within the pylon 31. The processing unit 31 can be located in the cabinet 22, the arm 24 or the terminal 41. It is also preferred that the terminal 41 include a display 26. An arm 24 is provided to support the display 26 to the pylon assembly 30 and allow for movement of the terminal 41. Preferably, the arm 24 is an articulated arm. The display 26 is positioned by grabbing handles 42 on the display 26 and then moving the display 26 to the desired location. The display 26 remains in place through friction in a manner well known in the art. In another embodiment, a mechanism can be provided to automatically raise the display 26 and articulated arm 24 to the uppermost, retracted position on undocking of the cabinet 22 from the pylon assembly 30. Such a mechanism may use a damped spring driven action where the user pulls down the display 26 to use it, thereby priming the spring (not shown). It should be noted that the display 26 may also articulate horizontally away from the patient side at its point of connection to the articulated arm 24. This provides a level of privacy to the caregiver using the terminal 41.

In yet another embodiment, the arm is deleted and the connections between the pylon 30 and the terminal 41 are wireless.

With continuing reference to FIGS. 1 and 3-5, there are two preferred configuration embodiments for the terminal 41: (1) integrated and (2) PatientStation system plus cabinet 22 and pylon 30. Both embodiments have many features in common. In the PatientStation configuration, terminal 41 is mounted on its own pole (not attached to pylon assembly 30) at a safe, but convenient distance from the patient bed (not shown).

There are many optional additional features available to use with the terminal 41. These features include a video camera 44, a card reader 46 (also referred to as a swipecard reader because the card being used with the reader is quickly moved, “swiped,” through the reader), a touchscreen 48, a speaker 50, a bar code scanner 52, a microphone 54, biometric fingerprint reader 43 and a call/power button 56. Because the patient will need to “loan” the display 26 to the caregiver when medical or other supplies need to be accessed, the POC station 20 will ideally include a wired or wireless remote control (not shown) that the patient can use to change volume and channel, and pause whatever movie or the like the patient may be viewing. The basic operation of these features is known in the art and thus will not be described in detail.

Still referring to FIGS. 1 and 3-5, the terminal display 26, whether integrated or PatientStation machine, provides access to clinical information and non-clinical information. In order to access the clinical information, special access must first be granted. Two levels of access to the POC station 20 software systems are supported. Before medication can be dispensed, the caregiver preferably must need to use two levels of security. One preferred method is to have the caregiver use a swipecard authenticated with either password or fingerprint. The POC station 20 can be used with cards with a magnetic strip or chip, proximity cards or chips that the caregiver would have on them, and the like. The POC station 20 may also require a password and ID entry in order to gain access to the items stored in the compartments 28. However, for supplies where security is still important but less critical only one level of security such as a swipecard or biometric scan is required. This allows caregivers to quickly swipe; open a drawer 28, take supplies, record what they have taken via the touchscreen 48 menu, and log off/allow to time out. When the system detects an open drawer 28, the pick/put interface for that drawer 28 appears on screen. This allows the less security-critical supplies to be accessed and recorded with the minimum of interaction steps. Closing the medical drawer 29 starts a time-out to log off and locking of supply drawers 27.

The nurse uses the display 26 to interact with the POC station 20. If the patient is using the display 26 at that point in time, the nurse may, as noted above, request use of the device. This will require the patient to stop using the display 26 until the nurse has finished with the POC station 20. This “monitor borrow” must be transacted with respect for the patient's privacy (in the case of internet and e-mail/chat use) and enjoyment (in the case of TV/movie viewing). Cost is also an issue if the patient is watching a pay-per-view movie. As a result, alternate ways for the nurse to borrow the display 26 are provided: (1) patient initiated and (2) nurse initiated. For such borrowing, the display 26 screen has a “sleep” button that the patient can use to pause any internet/movie watching activity, and hide it from view. This could be made password protected so the patient feels his/her mails remain private.

For nurse initiated borrowing, the nurse informs the patient that the nurse is about to switch over the monitor screen so clinical information can be accessed. In order to attain this access, the nurse may use clinical access means. This clinical access means may be a card reader 46 as noted above. To gain clinical access, the nurse may simply place (or swipe) the appropriate card through the card reader 46 or do a biometric scan to identify him/her self. Once the system recognizes the nurse, the patient will see his/her screen content pause and disappear, to be replaced by the POC station interface (not shown). In one embodiment, a transition screen is provided to further reinforce that the patient's work/e-mail/movie is not lost and is secure.

If the display 26 has been idle for a predetermined time, such as 3 minutes, the system will automatically log off. To log back on at the same point in the POC station interface, only the second password or biometric finger scan stage is required; the caregiver's location in the interface architecture is preserved. A new caregiver who logs on after a previous user has timed out will get the startup screen. Preferably, the POC station 20 displays a fast log out button to allow caregivers to interrupt their session and leave the room momentarily.

The nurse uses the POC station 20 software to select the medications the nurse intends to administer to the patient. This presents an opportunity for performance support functions such as a patient safety check. One example is that the display 26 screen provides a question concerning the patient such as “Have you eaten in the past 4 hours?” For controlled substances, the caregiver may need to re-authenticate, or use an additional password before the drugs are released. Certain caregivers may not have access to controlled substances. In this case, the system will require a second person to authorize this medicine without restarting the session.

To access items within the drawers 28, while a caregiver is logged on, any one of the authorized drawers 28 can be opened. In another embodiment, while a caregiver is logged on, one or more of authorized supply drawers 27 can be opened. In both of these embodiments, the needed item can be retrieved and recorded on-screen. This mode of interaction works best for caregivers with a clear mental picture of where items are in the cabinet 22, or who can quickly recognize an item on sight. This mode also allows items to be accessed and recorded while the interface is in mid-operation on another task. In another embodiment, the display 26 provides a screen interface for each drawer 28. This interface may illustrate any and all the items and their locations in drawer 28 sections. This may be shown graphically with pictures or a list of items and their locations. This may help the caregiver to intuitively direct their attention to relevant items.

If the caregiver takes nothing from the drawer, the on screen menu for that drawer 28 will persist (even if the drawer 28 has been shut again) until the caregiver presses the “none taken” button or goes to the next screen if another drawer 28 is opened. If the caregiver has taken item(s) and has recorded what the caregiver has taken on the touch screen, the menu will disappear when the caregiver shuts the drawer 28. In another embodiment, an “out of stock” button can be provided beside each item button to inform restockers about items that need more urgent attention—for example, a nurse needed a particular item but the item was not there. In yet another embodiment, a “dispatch” button could be provided to get a restocker to come to the room immediately with a refill.

This POC station 20 according to this invention has benefits in an emergency where a nurse needs a supply urgently but does not have time for lengthy screen-based interactions before getting it. In an urgent situation, the caregiver can use the “swipe-open-take-shut” feature. In that event, there is no record of what the nurse took, but the system records who took something. If another nurse is present at the time, the other nurse can input the “order” on behalf of their colleague.

An alternate mode of entry could be accessed via an on-screen menu of all available items. This allows items to be chosen alphabetically or by category. This menu allows the quantity of each item that is needed to be chosen and then graphically indicates which drawer and/or location in the drawer from which to retrieve the item.

It is well known to use restockers to replenish items of all types (including medications) within a health care facility. The term restocker includes supply restockers and medical restockers. Although these are often two distinct sets of workers, many of the issues surrounding POC restocking are common to both. The complexity of restocking on a per room basis depends on the level of variability in stock sets between stations. Given that the POC station 20 has less capacity than the existing centrally located nurse station, some subset of the pharmacopoeia will need to be delineated. Several options are possible, including: (1) the cabinets may carry a set of common medications and supplies; (2) there may be a different set of medications per specialty unit of the hospital; (3) the set of medications might focus on all medications that need to be administered in a timely or urgent manner; (4) the set of medications may be customized to match each patient's potential needs. This set might purposely omit drugs that may conflict with each other, or to which the patient is allergic. Before a restocking run, the restocker will need to know what needs to be replenished, or which medicines/supplies have passed expiry and need replacing.

An alternative approach to loading the restocking cabinet with a custom set of restock each day would be to divide the load into routine and extra items. Each cabinet would be routinely loaded with a set of items most likely to be used in an average restocking run. This routine set could develop over time as the system learned the flow of medicines/supplies. The routine set could also account for typical additional usage while the restocker is on a run. The extra set would include all medicines/supplies that fell outside the average. This simplifies preparation of the restocking cabinet into a larger routine task, and a smaller task that changes each time. Importantly, the POC station 20 of this invention can work equally well with all the restocking variations discussed.

In one embodiment, the POC station 20 may allow caregivers to tell the system when a particular item had run out and needed to be restocked. At least three alternate policies for use of this interface are possible and are fully supported by this invention: (1) a button is to be pressed any time anybody notices a depleted item; (2) a button is pressed when lack of an item has inconvenienced a caregiver; (3) a button which is a panic button and requests a restocker to immediately bring a set of new stock for that POC station 20. In the first case, the input helps the system stay in touch with reality but it depends on caregivers to perform additional audit tasks that may be irrelevant to the jobs at hand. The second option is more relevant to a caregiver's task and will send a strong message to the system that it needs to adjust its routine set or increase cabinet capacity for that item. The third option is also a valid use in some cases.

For restocking purposes, the POC station cabinet 22 can be wheeled out of the patient room—for example, into the medical facility hall or corridor—by the nurse. This permits the restocking staff to refill the station without entering the patient room. Also, a different POC station 20 can be rolled into the room to replace the other one. With these scenarios, disturbance is kept to a minimum and restocking staff do not need to be authorized to enter patient areas. Such out of room restocking requires a network connection to enable the cabinet 22 to release CUBIE receptacles that need replenishing. One method of accomplishing this is to incorporate a radio frequency (RF) networked computer into the restocking cabinet (not shown). The restocker would then dock or connect the POC station cabinet 22 to their networked restocking cabinet. The restocker would then be able to see on their restocking monitor which items need to be refilled and access the appropriate drawers 28.

Another embodiment that permits placing cabinets on-line while outside the patient room requires that the restocker carry a light portable computer (not shown) which interfaces with the cabinet through a secondary data port. This approach would require the addition of a battery power source to the cabinet 22 for powering its electronics and actuators. This solution makes the restocking cabinet more “low-tech” and thereby more cost effective and flexible.

For in-room restocking, it is best that the restocker knows what to bring with them before they enter the room. This allows them to prepare the new stock outside the room and then quickly enter and use-the terminal 41 to access the drawers 28 and distribute the stock across relevant drawers 28. For this task, a printed restocking report for each room may be used. This option is “low tech” and cost effective but unlike a wireless pocket PC system, the printed restocking report may have become out of date in the course of the restocking run. This discrepancy may not be critical. In-room restocking does not require the more sophisticated networked medical and supply restocking cabinets. However, as restockers will leave their cabinet unattended in the hall or corridor, security becomes a concern. The restocking of cabinets needs to be carefully designed to prevent unauthorized access to medical items.

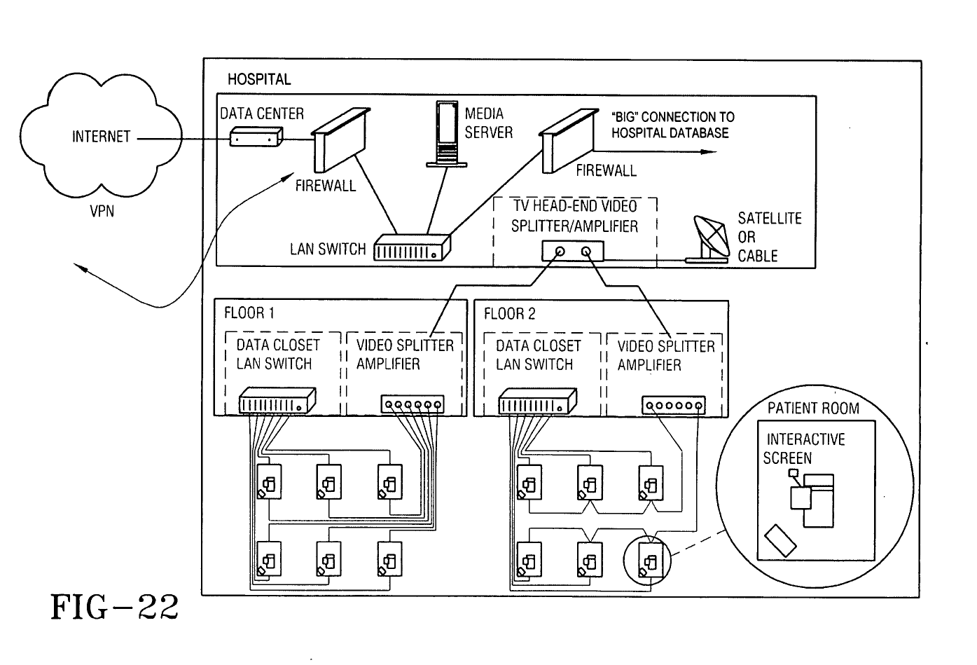

The network infrastructure for the POC station 20 is a communication layer that enables data and television signal transmissions. See FIG. 22. Data cabinets contain LAN switches as well as video amplifiers and dividers. Standard architecture requires the use or the installation of data cables from the selected data cabinet to the patient rooms. An alternate technology would use existing phone cabling of the hospitals to transport data thus avoiding the cost and deadlines associated with the installation of new cabling.

The local data center is a group of equipment, located at one or several central rooms, which provides television (TV head-end), Internet and video-on-demand services and other services. This local data center also includes the central equipment such as the content server, network switches, firewalls, Internet access, etc.

As noted above, the POC station 20 of this invention provides access to both clinical information and non-clinical information. While the clinical features are targeted for use by the caregiver, the non-clinical features are targeted for use by the patient and the patient's family/friends who visit the patient. This invention offers a wide variety of bedside features and services to patients. Before using the PatientStation machine, the patient user needs to subscribe. Screen instructions guide the patient users through subscription process. After having subscribed, the only device with which the patient/visitors need to interact is a touch-screen display 26.

The POC station 20 may also have a virtual keyboard thus there is no need for a physical keyboard. The virtual keyboard automatically appears when the system detects a type-in field, whether on the Internet or in any other application running on the system. The virtual keyboard is a feature that hospital staffs appreciate even more than the wireless keyboards because it minimizes the number of objects in the room and also decreases the risk of infection and contamination.

The POC station 20 also comprises communication elements or a messaging feature. The messaging feature is a simplified E-mail system allowing patients/visitors to send and receive e-mails. In one embodiment, the e-mail address of a patient is a combination of his/her home phone number and room number.

The POC station 20 may also comprise a patient education element. Instead of having the medical staff convey a video system and educational videos to a patient's room, they can make the videos or other educational materials available online in a digital format and users can then watch them at their convenience. This feature can save hospital staff time and make the education process more efficient. Another advantage is that it allows for computer-based training. As a result, information can be delivered to the patient and the patient can then be immediately tested to get feedback on what has been learned. This minimizes the need for further nurse intervention.

The POC station 20 can also include means to replace the conventional telephone handset. Using telephone over IP technologies, patients can call and receive telephone calls directly from the terminal 41. The telephone is built around the speaker 50 and microphone 54 and can be used as a normal telephone to make local or long distance calls. Interaction with the video camera 44 again only requires access to the touch screen. With the video camera 44, if the person to whom the patient is talking has a webcam and has downloaded the appropriate software (that is available on the Internet), both can optionally view the person to whom they are talking.

As noted above, the POC station 20 of this invention also provides access to clinical features that are targeted for use by the caregiver. In one option, access to the health facilities information technology (IT) system for patient's record or any other medical application is provided. Interfaces with nearly every major system vendor as well as proprietary system interfaces have been developed. These interfaces allow for the transfer of patient Admission/Discharge/Transfer (ADT) information as well as medication and supply billing and usage data. Other interfaces provide Electronic Data Interchange (EDI) with many of the health care facility's wholesalers. This enables the health care facility to place quicker orders resulting in timely restocking of medications and supplies.

One of the major advantages of the POC station 20 is the availability of the Bedside Information Gateway (BIG) as an option that can be used with all its systems. BIG is an application-independent system that allows easy and efficient access to mission-critical applications directly from the POC station 20 machine. It makes it possible for the medical staff to leverage applications throughout the facility regardless of the technology (Web or Windows) used for these applications. BIG makes it possible for physicians and nurses to access quickly and easily a wide variety of medical applications and information, therefore shortening the time it takes the caregiver to make rounds. Whether used to consult a patient file, access laboratory/radiology results or prescriptive applications, the POC station 20 simply acts as a window on the applications inside the hospital mainframe. With the BIG technology, the only thing required to implement verification is the purchase of verification software.

The basic physical components used in the POC station 20 have been described above. Now, however, more detailed information will be provided. Again it should be noted that these are just examples and numerous modifications can be made and still fall under the invention as here described and claimed.

As discussed briefly above, the POC station 20 according to this invention may be integrated into a larger, perhaps care facility(ies) wide, system for controlling supplies and medicines. For one example, the POC station 20 is intended as a complement to two other devices known as the Pyxis MedStation and the Pyxis SupplyStation units. In one recommended use, high use and patient specific medications are stored in the POC station 20 while the MedStation unit maintains first dose and controlled medications. Slower moving drugs can be placed in the MedStation unit while the fast moving medications can be placed within the cabinet 22 of the POC station 20. The MedStation and SupplyStation units can be used to manage bulk items while the POC station 20 can manage patient specific medications and supplies. It should be noted that the POC station 20 is preferably provided with the necessary software to interface with the MedStation units.

### EXAMPLE 1

A POC station 20 as described above is placed in a patient's room in a health care facility. In order to take/return items after a medicine or supply order has been initiated, the following procedures were used. Note that integrated take/return is designed for situations where a nurse plans to dispense both medicines and supplies during the same transaction.
a. Log on
b. Select the electronic medication administration record (MAR) icon or the “Remove Chart” (Med) icon from the patient care section of the main menu
c. Scan patient wrist band
d. Supply drawers 27 unlock
e. Pull open one or more supply drawers 27
f. The screen displays the drawer pocket configuration, with a “Take and Return” button for each loaded item
g. Press “Take” button for each item to take—item being “Taken” will be visibly distinguished on the screen from all other items in the drawer
h. Push drawer closed when finished taking items from that drawer
i. When the drawer is closed, the user is returned to the previous screen to continue the medicine dispensing process, or
j. User selects “Main Menu/Complete/Done” button on screen, or
k. Repeat step f through step j for each subsequent drawer access to remove additional supplies
l. Log off: this sends all supply transactions to the central supply for processing

### EXAMPLE II

In order to refill supply items, the following procedures are used
a. Log on
b. Select the “Refill” icon from the materials management section of the main menu
c. All supply drawers unlock
d. Screen displays a “virtual cabinet” that highlights all supply drawers—each drawer will display an option, free text “drawer description” for the user to easily identify drawer contents prior to opening
e. Pull open one or more supply drawers 27
f. The screen displays the drawer pocket configuration, with a “Take and Return” button for each loaded item
g. User selects 1 of 2 options:
h. Option 1: refill all
   (1) Updates all items in the drawer to their par value
   (2) Refill items
   (3) Close drawer
i. Screen displays “virtual cabinet” that highlights all Drawers
j. User selects “Main Menu/Complete/Done” button on “virtual cabinet” screen
k. Option 2: refill to par
   (1) All items with current count below par will be highlighted
   (2) User selects first item to refill
   (3) Screen displays:
      i. Current count
      ii. Refill amount
      iii. Par level
      iv. Verify Count (check box)
   (4) Refill items
      i. Repeat i though iv for each subsequent item to refill
   (5) Close drawer
l. Screen displays “virtual cabinet” that highlights all drawers
m. User selects “Main Menu/Complete/Done” button on “virtual cabinet” screen
n. Log off: this sends all transactions to the central supply for processing

As discussed above, the drawers 28 may be secured and electronically controlled. As also discussed above, the supply drawers 27 may be securable with a securing means that is different, and preferably easier to overcome, than the securing means used with the medicine drawers 29. Preferably there is at least one supply drawer 27 that the patient can open and close easily—with a key or password. This can be accomplished by using a software feature. Entry of the key or password unlocks the drawer so that the patient can open it. This patient drawer could also be unsecured, so it can be opened without a key or password. The user has to push the drawer to “close” it.

Industrial Applicability

The health care industry is constantly searching for new equipment and procedures which increase productivity, reduce costs and most importantly enhance patient safety. The point-of-care station according to this invention combines a number of known technologies in a new structure that is placed next to the patient's bedside. The POC station in its basic configuration comprises a mobile cabinet with securable drawers, a pylon release mechanism, an immovable pylon, an articulated arm, a terminal having a monitor and a computer with associated software. Through placing the inventive station in the patient's room, increased caregiver productivity can be realized, while costs can be reduced and patient safety enhanced.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A point of care station comprising:
a cabinet having at least a first securable compartment that is adapted to hold items;
a pylon assembly; and
docking means for use in docking the cabinet to the pylon assembly and also for use in undocking the cabinet from the pylon assembly.

2. The point of care station of claim 1 additionally comprising a processing unit and a terminal, wherein said processing unit is operatively connected to the terminal.

3. The point of care station of claim 2 wherein said terminal comprises a display means and input means.

4. The point of care station of claim 1 wherein said terminal additionally comprises means to access clinical and non-clinical information.

5. The point of care station of claim 3 wherein said display is adapted to illustrate any and all items within said first securable compartment.

6. The point of care station of claim 3 wherein the said input means is adapted to record the status of items within the first securable compartment.

7. The point of care station of claim 4 wherein the access to non-clinical information comprises access to at least one feature selected from the group consisting of television, internet, digital video, movies, music, games, electronic purchases, messaging tools, telephone and patient educational services.

8. The point of care station of claim 4 wherein the access to clinical information comprises access to at least one feature selected from the group consisting of medical records, billing records, vendor information, inventory management, hospital services, digital imaging, medicine usage data, medical test results, and electronic purchases.

9. The point of care station of claim 1 wherein said pylon assembly is fixed to a room surface.

10. The point of care station of claim 2 further comprising an arm that supports said terminal.

11. The point of care station of claim 10 wherein said arm is articulated.

12. The point of care station of claim 10 wherein said terminal further comprises at least a first handle adapted for moving said terminal with respect to the pylon assembly and with respect to the arm.

13. The point of care station of claim 2 wherein said terminal further comprises at least one item selected from the group consisting of a magnetic card reader, biometric reader-sensor, proximity reader, radio frequency identification reader, speakers, headphone connection, telephone, symbology reader, video camera, bar code reader, touchscreen monitor and call button.

14. The point of care station of claim 1 wherein the pylon assembly provides at least one of power and communication link to the cabinet when the cabinet is docked to the pylon assembly.

15. The point of care station of claim 1 wherein said cabinet is movable.

16. The point of care station of claim 1 wherein said cabinet is adapted to be physically secured to said pylon.

17. The point of care station of claim 15 wherein said cabinet additionally comprises at least one wheel.

18. The point of care station of claim 17 wherein said cabinet additionally comprises at least a first handle for use in moving the cabinet.

19. The point of care station of claim 1 wherein the first securable compartment is unlocked by the processing unit.

20. The point of care station of claim 1 wherein said compartment is a drawer.

21. The point of care station of claim 13 wherein the first securable compartment adapted for holding medications, the cabinet further comprising at least a first supply compartment for use in holding general supplies.

22. The point of care station of claim 21 wherein the first supply compartment comprises a handle and the first securable compartment does not.

23. The point of care station of claim 19 wherein the first securable compartment automatically opens a short distance from the cabinet when said compartment is unlocked.

24. The point of care station of claim 2 wherein said processing unit is operatively connected to said cabinet.

25. The point of care system of claim 2 wherein said processing unit is operatively connected to said terminal via a wireless communications link.

26. The point of care station of claim 24 wherein said processing unit is operatively connected to said cabinet via a wireless communications link.

27. The point of care station of claim 2 wherein said processing unit is located in one of the group consisting of said cabinet, said pylon assembly and said terminal.

28. The point of care station of claim 10 wherein said processing unit is located in said arm.

29. The point of care station of claim 1 wherein said docking means is a communications link between said cabinet and said pylon assembly and said cabinet is not physically secured to said pylon assembly.

30. The point of care station of claim 19 wherein the cabinet further comprises indicator means for indicating if the first securable compartment is unlocked or for indicating if the first securable compartment contains a selected item.

31. The point of care station of claim 30 wherein said indicator means comprises at least a first indicator light mounted on the cabinet.

32. The point of care station of claim 1 wherein the cabinet further comprises an illumination source adapted for use in illuminating said compartment.

33. The point of care station of claim 27 wherein said illumination sources is disposed within a handle attached to the cabinet.

34. The point of care station of claim 19 wherein the cabinet further comprises a manual release mechanism for use in unlocking the first securable compartment without electric power and access means for use in accessing said manual release mechanism.

35. The point of care station of claim 1 further comprising a security system for use in detecting whether the cabinet has been moved without proper authorization.

36. The point of care station of claim 1 wherein said docking means comprises a latch mechanism.

37. The point of care station of claim 1 wherein the docking means comprises a latch release mechanism for use in unlocking the cabinet from the pylon.

38. The point of care station of claim 37 wherein said latch release mechanism comprises a foot pedal extending from the cabinet.

39. A method of managing medical items comprising the steps of providing a point of care station comprising: (1) a cabinet having at least a first securable compartment; (2) a pylon assembly comprising a processing unit; said cabinet and said pylon being docked; and (3) a terminal;
providing first security information to unlock said first compartment;
opening said first compartment; and
adding first items to said first compartment.

40. The method of claim 39 further comprising the steps of:
providing the first security information to said terminal to unlock said first compartment;
opening said first compartment; and
removing one or more of the first items from said first compartment.

41. The method of claim 39 additionally comprising the step of closing and locking said first compartment.

42. The method of claim 39 wherein the step of providing first security information to said terminal to unlock said first compartment, comprises at least one step selected from the group consisting of inputting a password, of swiping a card through a card reader, using a bar code scanner, using a biometric reader, using a proximity reader, using an radio frequency identification reader, and using a symbology reader.

43. The method of claim 39 wherein the step of providing first security information to said terminal to unlock said first compartment, comprises at least two steps selected from the group consisting of inputting a password, of swiping a card through a card reader, using a bar code scanner, using a biometric reader, using a proximity reader, using an radio frequency identification reader, and using a symbology reader.

44. The method of claim 39 additionally comprising the steps of:
providing the cabinet with a second compartment;
providing second security information that is distinct from the first security information to unlock said second compartment;
opening said second compartment; and
adding second items to said second compartment.

45. The method of claim 44 wherein said first security information is insufficient to unlock said second compartment and said second security information is insufficient to unlock said first compartment.

46. The method of claim 39 additionally comprising the step of gaining access to clinical information.

47. The method of claim 39 additionally comprising the step of recording information about the first items in said terminal.

48. The method of claim 40 additionally comprising the step of displaying information about the contents in said first compartment on said terminal.

49. The method of claim 48 further comprising the steps of:
providing the cabinet with a second compartment; and
displaying information about the contents in said second compartment on said terminal.

50. The method of claim 39 further comprising the steps of providing the cabinet with a second compartment.

51. The method of claim 39 wherein the method additionally comprises the steps of:
undocking the cabinet from the pylon assembly; and
moving the cabinet from said pylon assembly.

52. A method of accessing information comprising the steps of:
providing a patient care station comprising: (1) a cabinet having at least a first electronically securable compartment; (2) a pylon assembly comprising a processing unit; and (3) a terminal; said station being proximate to a patient bedside;
providing first security information to said terminal; and
accessing clinical information.

53. The method of claim 52 wherein prior to the step of providing first security information to said terminal, the method additionally comprises the step of activating a sleep button that pauses a prior activity on said terminal.

54. The method of claim 52 wherein the step of providing first security information comprises at least one step selected from the group consisting of inputting a password, of swiping a card through a card reader, using a bar code scanner, using a biometric reader, using a proximity reader, using an radio frequency identification reader and using a symbology reader.

55. The method of claim 52 wherein the step of providing first security information comprises at least two steps selected from the group consisting of inputting a password, of swiping a card through a card reader, using a bar code scanner, using a biometric reader, using a proximity reader, using an radio frequency identification reader, and using a symbology reader.

56. The method of claim 52 further comprising the steps of:
providing second security information to the terminal; and
accessing non-clinical information.

57. The method of claim 56 wherein the step of accessing non-clinical information additionally comprises at least one step selected from the group consisting of viewing television on the terminal, accessing the internet from the terminal, viewing a digital video on the terminal, viewing movies on the terminal, listening to music from the terminal, making electronic purchases with the terminal, using messaging tools on the terminal, making a telephone call with the terminal, playing a game on the terminal, and accessing email with the terminal.
